(19) United States
(12) Patent Application Publication
(10) Pub. No.: US 2009/0214911 A1
(43) Pub. Date: Aug. 27, 2009

(54) DIRECT ALCOHOL FUEL CELL

(75) Inventors: Masakazu OHASHI, Koto-ku (JP); Zhen GUO, Koto-ku (JP); Kuohao TSENG, Koto-ku (JP)

Correspondence Address: SUGHRUE MION, PLLC, 2100 PENNSYLVANIA AVENUE, N.W., SUITE 800, WASHINGTON, DC, 20037, US

(73) Assignee: Fujikura Ltd., Koto-ku (JP)

(21) Appl. No.: 12/392,743

(22) Filed: Feb. 25, 2009

(30) Foreign Application Priority Data
Feb. 26, 2008 (JP) 2008-45203
Feb. 26, 2008 (JP) 2008-45204

(51) Int. Cl. H01M 8/18

(52) U.S. Cl. 429/20; 429/19

(57) ABSTRACT

A direct alcohol fuel cell comprising a membrane-electrode assembly, on which electrodes are formed on both faces of an electrolyte membrane; a fuel chamber and an air chamber formed on the electrodes; a fuel tank; a supply conduit communicating the fuel tank and the fuel chamber; and a vapor chamber provided on the supply conduit, wherein the vapor chamber is provided with an oxidation catalyst and an admission port for aspirating emission from the fuel chamber containing the unburned alcohol fuel to the oxidation catalyst. A direct alcohol fuel cell further comprising a noncondensable gas mixing section comprising a noncondensable gas tank; a noncondensable gas supply conduit communicating a supply conduit and the noncondensable gas tank; and a catalyst provided on the noncondensable gas supply conduit

This application claims benefit of Japanese Patent Applications Nos. 2008-045203 and 2008-045204 both of which filed on Feb. 26, 2008 in the Japanese Patent Office, the disclosures of which are incorporated herein by reference in their entirety.

### FIELD OF THE INVENTION

The present invention is related to a fuel cell, which is used as an electric source in a wide range of electrical equipment from small devices such as a laptop computer, a cellular phone, a video camera, to large devices such as household equipments and automotive equipments.

### BACKGROUND

### Discussion of the Related Art

A direct alcohol fuel cell is capable of generating electric power at relatively cold temperature. Moreover, the energy density of liquid fuel for the direct alcohol fuel cell is higher than that of flammable gas, thus a fuel canister of the direct alcohol fuel cell can be downsized. Further, hydrogen gas, which is difficult to store, is not used as the fuel for the direct alcohol fuel cell. For the foregoing reasons, the direct alcohol fuel cell is advantageous in miniaturizing a structure of a fuel cell. Therefore, the direct alcohol fuel cell is expected to be applied as an electric source widely for small portable electrical equipments such as a laptop computer, a cellular phone, a video camera and so on.

However, power output of the direct alcohol fuel cell is less than that of the fuel cell using hydrogen gas as the fuel. Therefore, the electric generating capacity of the direct alcohol fuel cell has to be enhanced.

Direct methanol fuel cells using methanol as liquid fuel are categorized into two types according to the method of supplying fuel to a cell. Specifically, the direct methanol fuel cells are categorized into a liquid fuel supply type in which liquid fuel is delivered to the cell, and a vaporized fuel supply type in which vaporized methanol is delivered to the cell.

Liquid methanol supplied from a fuel supplying side of the liquid fuel supply type direct methanol fuel cell is transmitted to a catalyst layer through an electrode of metal mesh and a gas diffusion layer of porous material. The catalyst layer is made of a compound of platinum with ruthenium. When methanol and an equal or more amount of water reach the catalyst layer, or in the case wherein methanol and an equal or more amount of water exist in the catalyst layer, methanol is decomposed by the catalyst into carbon dioxide, protons and electrons. Specifically, the reaction as expressed by the following equation is achieved by platinum arranged on an air supplying side:

CH₃OH+H₂O→CO₂+6H⁺+6e⁻ (1).

The generated carbon dioxide is emitted through the gas diffusion layer and the electrode through which the fuel has been transmitted; the generated proton migrates to the air supplying side across an electrolyte membrane; and the generated electron migrates through the porous gas diffusion layer functioning as a conductor, gets trapped at the electrode, and then migrates in a circuit formed between the electrodes of both the fuel and air supplying sides to generate electricity.

In order to easily transmit both liquid and gaseous matters therethough, and to trap electricity, and to further avoid electrical corrosion of the electrode, the electrode is preferably made of gold or platinum-plated mesh of iron or copper.

Also, in order to easily transmit both liquid and gaseous matters, the gas diffusion layer is preferably made of good conductor such as carbon fiber or carbon paper. More preferably, the material of the gas diffusion layer is subjected to a hydration treatment to more easily transmit the liquid matter therethrough. In general, such hydration treatment is carried out by impregnating the carbon fiber or the like with tin oxide.

Air is sucked into the fuel cell under standard atmospheric pressure from the air supplying side. When oxygen contained in the sucked air reaches the catalyst layer through the electrode and the gas diffusion layer of the air supplying side, the oxygen reacts with the protons and electrons migrated from the fuel supplying side to produce water as expressed by the following equation:

3/2O₂+6H⁺+6e⁻→3H₂O (2).

However, it is insufficient for the above-explained commonly-used methanol fuel cell to generate the required electrical power stably by merely supplying liquid alcohol thereto under standard atmospheric conditions. Therefore, according to the conventional art, methanol is supplied to the electrode of the fuel supplying side using a small pump while controlling the flow rate of the methanol.

Indeed, the above-described conventional fuel cell employing such a fuel-supply pump is too large for small electrical equipments such as a cellular phone. Moreover, electric power is required to operate the pump, which means that the output of the fuel cell is degraded as a consequence of the electric power generated by the fuel cell itself being partially consumed to operate the pump.

In the case of the latter mentioned vaporized fuel supply type direct methanol fuel cell, according to the conventional art, liquid methanol fed by a pump is vaporized and then supplied to an electrode by a blower. In this case, electrode reaction is higher than that of the liquid fuel supply type direct methanol fuel cell. However, auxiliary equipment such as a vaporizer is required for this kind of vaporized fuel supply type direct methanol fuel cell. This means that a size of the vaporized fuel supply type direct methanol fuel cell is also enlarged by the auxiliary equipment.

In addition, in the conventional art, a wick structure has been employed as a fuel-supplying medium instead of the pump, thereby adopting a “passive” fuel cell system instead of a conventional “active” fuel cell system. In this case, an energy supply relating to a fuel supply can be minimized so that a fuel supplying system can be downsized. For this reason, versatility of the fuel cell as an electric source of small electrical equipments is expanded.

Japanese Patent No. 3442688 discloses a prior art of the wick structure functioning as a fuel-supply medium. According to the teaching of Japanese Patent No. 3442688, electrode reaction is improved to enhance an output of a liquid fuel supply type alcohol fuel cell, by introducing liquid fuel to an electric cell by capillary action, and vaporizing the supplied liquid fuel by reaction heat of a power section of the cell. The gaseous fuel in an evaporating layer is kept substantially saturated. That is, the liquid fuel is vaporized according to fuel consumption relating to cell reaction, and the vaporized amount of the liquid fuel is introduced to the electric cell by the capillary action.

Japanese Patent No. 3563648 discloses related art of this kind of liquid fuel supply type alcohol fuel cell. According to the teaching of Japanese Patent No. 3563648, hydrophilicity between the liquid alcohol fuel solution to be supplied by capillary action and the capillary is improved by adding surfactant to the liquid fuel.

On the other hand, the liquid fuel-housing tank taught by U.S. Pat. No. 6,506,513 is provided with pressure adjusting mechanisms for the purpose of supplying the fuel to the fuel cell body stably. According to the teaching of U.S. Pat. No. 6,506,513, pressure depletion in the fuel tank resulting from fuel consumption is adjusted by taking the outer air into the tank in accordance with the fuel consumption. Pressure rise in the tank resulting from fuel evaporation caused by temperature elevation raised by reaction heat of the cell is adjusted by discharging an inert gas in the tank. Thus, the inner pressure of the liquid fuel-housing tank of U.S. Pat. No. 6,506,513 is kept constant.

According to the teachings of Japanese Patent No. 3442688, however, methanol fuel is vaporized by the heat resulting from electric generation. Therefore, such vaporization of methanol and feeding of the vaporized methanol to the cell inevitably lag behind the generation. In other words, response to demand for generation is degraded. Moreover, methanol is heated by the heat resulting from generation, that is, heat quantity for heating methanol has to be limited by the generation amount. Therefore, the heat quantity for heating methanol is difficult to control. Furthermore, although methanol fuel has to be supplied continuously to constantly generate electricity, methanol rarely reacts completely. That is, unreacted methanol is inevitably discharged from the cell.

In addition to above-mentioned problem, according to the fuel cell taught by Japanese Patent No. 3442688, the methanol liquid is supplied to the fuel electrode and heated to be vaporized. As a result, the fuel electrode and vicinity thereof are saturated with the liquid. That is, carbon dioxide resulting from the reaction in connection with power generation cannot be discharged smoothly, and thus degrades power generation efficiency. The above-mentioned Japanese Patent No. 3563648 and U.S. Pat. No. 6,506,513 also present this problem.

### SUMMARY

It is therefore an object of the present invention to improve power generation efficiency of a direct alcohol fuel cell and to downsize the direct alcohol fuel cell.

In order to achieve the aforementioned objective, a direct alcohol fuel cell according to the present invention comprises: a membrane-electrode assembly, in which electrodes are formed on both faces of an electrolyte membrane; a fuel chamber to which liquid alcohol is supplied and which is formed on one of the electrodes; an air chamber which is formed on the other electrode; a fuel tank for containing the liquid alcohol fuel; a supply conduit communicating the fuel tank and the fuel chamber; and a vapor chamber which is provided on the supply conduit to vaporize the liquid alcohol fuel in the supply conduit by heating the liquid alcohol. The vapor chamber is provided with an oxidation catalyst for oxidizing the alcohol, and an admission port for aspirating emission from the fuel chamber containing the unburned alcohol fuel to the oxidation catalyst. A heat generated as a result of oxidizing the unburned alcohol at the oxidation catalyst is transferred to the alcohol in the supply conduit.

According to another aspect of the invention, a direct alcohol fuel cell comprises: a membrane-electrode assembly, in which electrodes are formed on both faces of an electrolyte membrane; a fuel chamber to which liquid alcohol fuel is supplied and which is formed on one of the electrodes; an air chamber which is formed on the other electrode; a fuel tank for containing the liquid alcohol fuel; a supply conduit communicating the fuel tank and the fuel chamber; a vapor chamber which is provided on the supply conduit to vaporize the liquid alcohol fuel in the supply conduit by heating the liquid alcohol fuel; and a noncondensable gas mixing section at which the vaporized alcohol to be fed from the vapor chamber to the membrane-electrode assembly is mixed with noncondensable gas. The noncondensable gas mixing section comprises: a noncondensable gas tank for containing hydrogen peroxide; a noncondensable gas supply conduit for communicating a supply conduit and the noncondensable gas tank; and a catalyst for decomposing hydrogen peroxide to produce oxygen, which is provided on the noncondensable gas supply conduit.

According to the direct alcohol fuel cell of the present invention, therefore, the liquid alcohol is heated to be vaporized in the vapor chamber on the way from the fuel tank to the fuel chamber. The liquid alcohol fuel thus vaporized is supplied to the fuel chamber via the supply conduit, and electricity is generated by an oxidizing reaction through the electrolyte membrane. The electric power thus generated is outputted from the electrodes. In this case, the alcohol fuel is pressurized as a result of being evaporated so that the alcohol fuel can be supplied to the fuel chamber in adequate amounts without using a mechanical pump. Moreover, since the alcohol fuel is evaporated, the alcohol fuel can diffuse easily into the fuel chamber entirely. That is, the evaporated alcohol diffuses all over the surface of the membrane-electrode assembly (MEA hereinafter) homogeneously. As a result, the MEA functions entirely thereby efficiently generating electricity.

According to the invention, even if plurality of MEA are laminated, the alcohol vapor can be supplied to the electrode of each layer of the fuel supplying side promptly and efficiently. Therefore, deterioration in generating efficiency can be minimized even if the plurality of MEAs is laminated. Moreover, no auxiliary equipment such as a pump is especially required for the direct alcohol fuel cell of the present invention. Therefore, the direct alcohol fuel cell can be downsized entirely.

In addition to the above explained advantages, according to the direct alcohol fuel cell of the present invention, the alcohol fuel is supplied to the MEA in vapor phase. Therefore, the surface of the MEA will not be saturated with liquid. Further, CO₂ gas resulting from the reactions in connection with the generation of electricity is allowed to flow smoothly without being hindered. Therefore, CO₂ can be discharged efficiently from the fuel chamber or the surface of the MEA so that the generating efficiency is improved. Furthermore, the partial pressure of the alcohol vapor can be lowered by mixing the alcohol vapor with the noncondensable gas. Therefore, the vaporized alcohol can be supplied to the electrode of the fuel supply side promptly and efficiently, and recondensation of the evaporated alcohol is thereby prevented.

### BRIEF DESCRIPTION OF THE DRAWINGS

These and other features, aspects, and advantages of the present invention will become better understood with reference to the following description and accompanying drawings, which should not be read to limit the invention in any way, in which:

FIG. 1 is a block diagram schematically showing a configuration of the direct alcohol fuel cell of the present invention;

FIG. 2 is a cross-sectional view of the membrane-electrode assembly;

FIG. 3 is a cross-sectional view showing a structure of the direct alcohol fuel cell of the present invention in more detail;

FIG. 4 is a graph indicating power generating characteristic of the present invention and power generating characteristic of comparative example in which liquid methanol is supplied directly to a power generation part;

FIG. 5 is a graph indicating power generating characteristic of the case in which PBI is used as the electrolyte membrane, and power generating characteristic of the case in which a polymer membrane of perfluorosulfonic acid series is used as the electrolyte membrane;

FIG. 6 is a block diagram schematically showing another configuration of the direct alcohol fuel cell of the present invention;

FIG. 7 is a view schematically showing an example of the supply conduit for supplying mixed fuel of liquid for producing the noncondensable gas and liquid alcohol;

FIG. 8 is cross-sectional view showing another structure of the direct alcohol fuel cell of the present invention in more detail;

FIG. 9 is a view schematically showing another example of the supply conduit for supplying mixed fuel of liquid for producing the noncondensable gas and liquid alcohol;

FIG. 10 is a graph indicating power generating characteristic of another example of the present invention and power generating characteristic of comparative example in which liquid methanol is supplied directly to a power generation part; and

FIG. 11 is a graph indicating power generating characteristic of the case in which PBI is used as the electrolyte membrane in another example of the invention, and power generating characteristic of the case in which a polymer membrane of perfluorosulfonic acid series is used as the electrolyte membrane.

### DETAILED DESCRIPTION

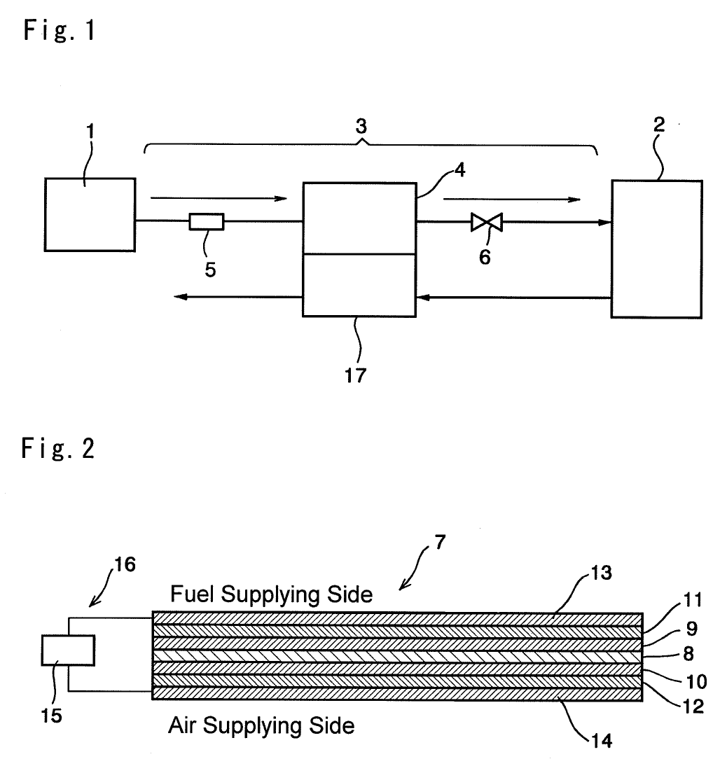

Here will be described an exemplary embodiment of the invention. FIG. 1 is a block diagram schematically showing a configuration of the direct alcohol fuel cell according to of the present invention. The direct alcohol fuel cell of the present invention comprises a fuel tank 1 for containing liquid alcohol, wherein the fuel tank 1 is communicated with a generating section 2 through a supply conduit 3. On the supply conduit 3, there is provided a vapor chamber 4 for vaporizing the liquid alcohol fuel by heating the liquid alcohol fuel in the supply conduit 3. A heat source of the vapor chamber 4 can be selected arbitrarily from an electric heater using an external power source, combustion heat of the alcohol fuel, etc. according to need. In the example shown in FIG. 1, oxidative heat of the alcohol fuel is used as the heat source.

A flow regulating mechanism 5 for controlling a flow rate of the liquid alcohol is arranged between the fuel tank 1 and the vapor chamber 4. A flow regulating valve or other appropriate structures such as an orifice or the like may also be employed as the flow regulating mechanism 5. On the other hand, a valve 6 for regulating flow rate of the alcohol vapor is interposed between the vapor chamber 4 and the generating section 2. Specifically, the valve 6 allows and interrupts the flow of the alcohol vapor.

The generating section 2 is composed mainly of a membrane-electrode assembly (hereinafter “MEA”) 7 in which a polyelectrolyte membrane as an electrolyte and electrodes are integrated, and the generating section 2 serves substantially as a fuel cell. FIG. 2 is a sectional view showing a cross-section of the MEA 7. As can be seen from FIG. 2, catalyst layers 9 and 10 are formed on both surfaces of an electrolyte membrane 8.

The electrolyte membrane 8 is formed of a polymer membrane of perfluorosulfonic acid series (e.g., Nafion® 117), or an electrolyte membrane of polybenzimidazole (as will be called PBI herein after). The electrolyte membrane of PBI is especially suitable for improving power generation efficiency by suppressing crossover of the fuel. Crossover is a phenomenon by which the alcohol fuel is transported from the fuel supply side to the air supply side without causing a reaction relating to electric generation (i.e., a cell reaction) in the electrolyte membrane 8 of the generating section 2.

In this example, the catalyst layer 9 of the fuel supply side is formed mainly of a platinum/ruthenium blend, and the catalyst layer 10 of the air supply side is formed mainly of platinum. On the surfaces of those catalyst layers 9 and 10, gas diffusion layers 11 and 12 are formed individually. The gas diffusion layers 11 and 12 are electrically conductive porous layer formed to create flow channels for the fuel and air to the surface of the catalyst layers 9 and 10. More specifically, the gas diffusion layers 11 and 12 are formed of carbon fiber mesh, which is subjected to a hydration treatment according to need. Further, electrodes 13 and 14, made of a good conductor, are formed on the surfaces of the gas diffusion layers 11 and 12. In order to transport the fuel and air to the catalyst layers 9 and 10 therethrough, the electrodes 13 and 14 have to be permeable to air. Therefore, the electrodes 13 and 14 are made of platinum-plated stainless steel mesh. Those electrodes 13 and 14 are connected to a load 15 to form a circuit 16.

According to the example shown in FIG. 1, the vapor chamber 4 is provided with a catalyst combustion chamber 17 for oxidizing the alcohol fuel by an oxidation catalyst such as platinum. Specifically, the catalyst combustion chamber 17 is adapted to evaporate the alcohol fuel in the vapor chamber 4 by transporting heat resulting from the oxidation. The vapor chamber 4 and the catalyst combustion chamber 17 are divided by a plate of good heat conductivity such as an aluminum plate or the like and therefore, the heat generated in the catalyst combustion chamber 17 can be transmitted efficiently to the alcohol fuel in the vapor chamber 4. For this purpose, the catalyst combustion chamber 17 is communicated with the generating section 2 to introduce emissions containing unburned alcohol fuel emitted from the generating section 2.

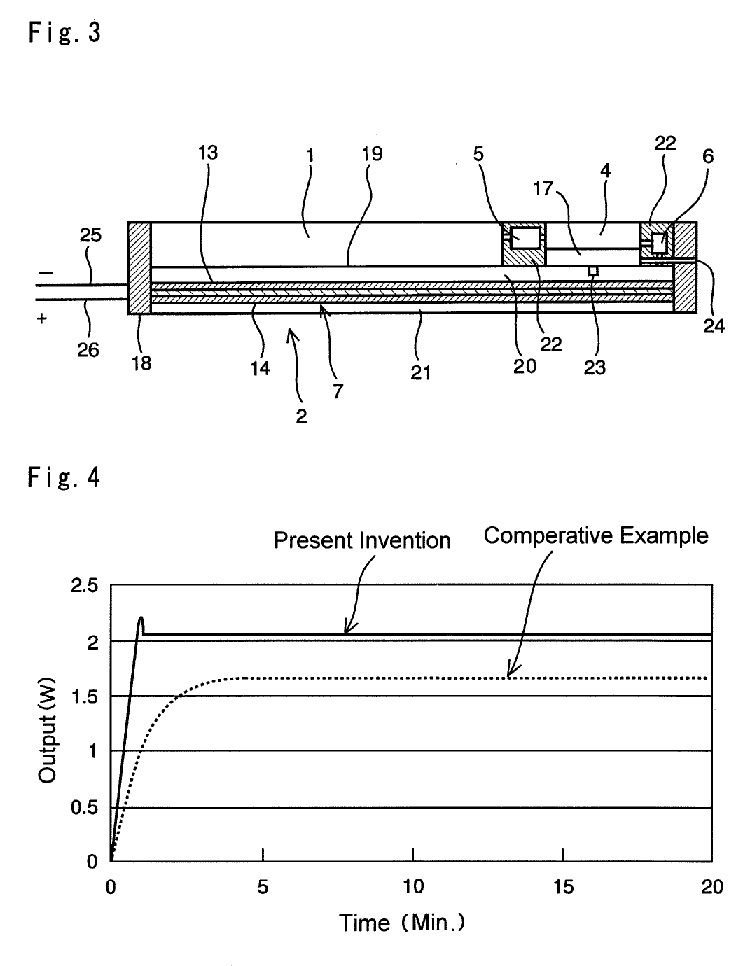

FIG. 3 shows the above-explained direct alcohol fuel cell of the invention in more detail. As can be seen from FIG. 3, an interior space of a hollow package 18 is divided by a partition 19. In the package 18, the fuel tank 1, the flow regulating mechanism 5, the vapor chamber 4, the catalyst combustion chamber 17 and the valve 6 are arranged in the upper side of FIG. 3, and the generating section 2 is arranged in the lower side of FIG. 3. As explained above, the generating section 2 is composed mainly of the MEA 7. The MEA 7 divides the lower space of the package 18 into two spaces. Specifically, the space between the partition 19 and the MEA 7 serves as the fuel chamber 20, and the opposite space serves as the air chamber 21. Although the fuel chamber 20 has to be a sealed space, the air chamber 21 is not necessarily to be sealed to introduce ambient air.

The fuel tank 1 is a sealed container provided with an inlet, not shown. The vapor chamber 4 is also a sealed container situated next to the fuel tank 1 across the flow regulating mechanism 5. In addition, a heat insulating material 22 is interposed between the conduit including the flow regulating mechanism 5 and the generating section 2. The catalyst combustion chamber 17 is formed between the vapor chamber 4 and the partition 19. In other words, below the vapor chamber 4 in FIG. 3, and the heat is transferred between the vapor chamber 4 and the catalyst combustion chamber 17 as explained above. As also explained above, the vapor chamber 4 and the catalyst combustion chamber 17 are divided by a plate having good heat conductivity such as an aluminum plate or the like.

A porous material to be impregnated with the liquid alcohol (i.e., methanol), for example, a wick material such as a carbon fiber to soak up the liquid alcohol by capillary action is contained in the vapor chamber 4. A catalyst, in which catalyst particles such as platinum are carried by a metal wick material, is contained in the catalyst combustion chamber 17. The catalyst combustion chamber 17 is provided with an admission port 23 opening to the fuel chamber 20 through the partition 19, and connected with an exhaust pipe 24 opening to outside of the package 18. The vapor chamber 4 is communicated with the fuel chamber 20 through a valve 6. Here, the valve is also covered by a heat insulating material 22. In FIG. 3, reference numerals 25 and 26 represent lead wires connected individually to the electrodes 13 and 14.

The principle of generating electric power by the fuel cell shown in FIG. 3 is same as that of the conventional alcohol fuel cell. That is, the electric power is generated by an oxidation reaction (i.e., generating reaction) via the MEA 7. Specifically, the methanol fuel supplied to the fuel chamber 20 is decomposed into carbon dioxide and protons by the reaction expressed by the above formula (1), and emits electrons. In this situation, the decomposed proton migrates to the air chamber 21 side through the electrolyte membrane 8. On the other hand, the emitted electron is outputted as electric power through the electrode 13. The proton migrates to the air chamber 21 side and reacts with oxygen in the air as expressed by the above formula (2), and water is thereby produced.

However, the methanol fuel supplied to the fuel chamber 20 will not react completely as explained above. That is, unburned methanol may remain in the fuel chamber 20, and such unburned methanol is introduced to the catalyst combustion chamber 17 from the admission port 23 before being emitted outside of the package 18. In other words, emissions from the fuel chamber 20 are introduced into the catalyst combustion chamber 17, and methanol contained in the emission is oxidized by the catalyst. The heat resulting from such oxidation is partially emitted outside of the package 18 with the emission from the exhaust pipe 24. The remaining heat is transferred to the vapor chamber 4 adjacent to the catalyst combustion chamber 17.

The liquid methanol is supplied to the vapor chamber 4 from the fuel tank 1, and the flow rate of the liquid methanol is regulated by the flow regulating mechanism 5. The liquid methanol thus supplied to the vapor chamber 4 is heated by the heat from the catalyst combustion chamber 17. In order to startup the fuel cell promptly even under cold climate, an electric heater may be used as an auxiliary heat source. The vaporized methanol fuel is then supplied to the fuel chamber 20 via the valve 6. This means that the methanol fuel is pressurized when supplied to the fuel chamber 20. For this reason, the fuel can be supplied to the generating section 2 in sufficient amount.

Since the methanol fuel is in gaseous phase when supplied to the fuel chamber 20, the methanol fuel diffuses in the fuel chamber 20 promptly. After the evaporated methanol fuel diffuses all over the surface of the electrolyte membrane 8 through the gas diffusion layer 11, the above-explained reaction is achieved at the catalyst layer 9. Therefore, the generating reaction takes place entirely in the electrolyte membrane 8, thereby generating electric power efficiently.

As expressed by the above equation (1), CO₂ is produced at the catalyst layer 9 as a result of dissociation of methanol. However, the methanol fuel is heated to be vaporized when supplied to the catalyst layer 9 and the gas diffusion layer 11, and therefore, a liquid film will not be formed on the catalyst layer 9 and the gas diffusion layer 11 so that the CO₂ gas resulting from the oxidation reaction can be emitted promptly and the methanol fuel can be circulated smoothly. Thus, the methanol fuel is supplied to the catalyst layer 9 and the electrolyte membrane 8 consecutively thereby generating the electric power efficiently.

The CO₂ gas resulting from the reaction expressed by equation (1) is introduced into the catalyst combustion chamber 17 from the admission port 23, and then emitted outside of the package 18 via the exhaust pipe 24. That is, the CO₂ gas also carries the unburned methanol to the catalyst combustion chamber 17. The unburned methanol is oxidized and decomposed into CO₂ gas and water in the catalyst combustion chamber 17. Therefore, the methanol fuel will not be emitted from the package 18, otherwise, only scarce amount of the methanol fuel is emitted from the package 18. Thus, as has been explained, the safety of the alcohol fuel cell according to the present invention is extremely high. Moreover, the alcohol fuel cell of the present invention does not require any power unit such as a pump so that the fuel cell itself can be downsized. In addition, generated electric power will not be consumed by such a power unit. Therefore, generation efficiency of the fuel cell can be improved.

### Example 1

A fuel cell illustrated in FIG. 3 was prepared. In this example, a diluted methanol solution containing 50% of water was used as fuel. In the experimental fuel cell, both the vapor chamber and the catalyst combustion chamber are sealed. Dimension of each chamber is 10 mm×10 mm×5 mm, and thickness of each part of those chambers was 1 mm. A wick material prepared by applying hydration treatment to carbon fiber was contained in the vapor chamber. Catalyst particles in which platinum was carried by the wick material were contained in the catalyst combustion chamber. The catalyst was prepared by immersing glass fiber rinsed in advance in an aqueous solution containing 10% of hexachloride platonic acid (i.e., hexahydrate), and heating the solution to 300° C. Then, hydrogen is reduced at room temperature thereby carrying platinum on the glass fiber as a wick material.

In this example, Nafion® 117 was used as a polymer membrane of perfluorosulfonic acid series. A blend of an equal amount of platinum and ruthenium was used to form a catalyst layer on the fuel chamber side, and only platinum was used to form a catalyst layer of air chamber side. The thickness of both catalyst layers was 20 μm. The catalyst layer was prepared by mixing catalyst powder into an alcohol solvent to prepare ink like material, and forming a catalyst film on a Teflon sheet using a screen printer. The catalyst film on the Teflon sheet was thermally pressed on an electrolyte membrane at 140° C. for five minutes, and then cooled while being pressurized to be transferred to the electrolyte membrane.

Further, gas diffusion layers were formed on both the catalyst layer of the fuel chamber side and the catalyst layer of air chamber side. Both of the gas diffusion layers were made of hydrated glass fiber and thickness thereof was 1 mm. On both of the gas diffusion layers, there are formed electrodes of platinum-plated stainless steel mesh, and the diameter of each opening of the mesh was 2 mm.

Those layered materials were pressed while being heated to be integrated as an MEA. In this situation, the area of electrode was 25 cm² (5 cm×5 cm).

A temperature of a partition plate dividing the vapor chamber and the catalyst combustion chamber was measured after a generation of the fuel cell is stabilized, and it was approximately 200° C. Since the boiling point of methanol is approximately 65° C. under the standard atmospheric pressure, it was confirmed that such an evolution of heat at the partition was sufficient for vaporizing methanol. FIG. 4 is a graph indicating electromotive force measured in this example. In FIG. 4, specifically, a continuous line represents power generating characteristic of the direct methanol fuel cell according to the present invention, and a broken line represents power generating characteristic of a comparative example such as a conventional fuel cell in which liquid methanol is supplied directly to a power generating section. As shown in FIG. 4, the output of the direct methanol fuel cell of the invention is higher than that of the comparative example in which liquid methanol is supplied directly to a power generation section. As also shown in FIG. 4, the output of the direct methanol fuel cell of the invention is much more stabilized in comparison with that of the comparative example.

As explained above, the vaporized alcohol fuel is used in the direct methanol fuel cell of the present invention. Alcohol crossover occurs if a general polymer membrane of perfluorosulfonic acid series is used as the electrolyte membrane. If such crossover occurs, the vaporized methanol is partially transported from the electrode of the fuel chamber side (i.e., an anode) to the electrode of the air chamber side (i.e., a cathode), and the transported methanol vapor reacts with oxygen from outside. That is, the oxidation reaction of the transported methanol vapor occurs on the cathode. As a result, an electrode potential is shifted to the minus direction and the electromotive force is thereby degraded.

The crossover phenomenon is likely to be induced in case the temperature of the electrolyte membrane is high and the concentration of the alcohol fuel is high. According to the direct alcohol fuel cell of the present invention, since the alcohol fuel such as methanol is heated to be vaporized, the temperature of the electrolyte membrane is thereby raised and the concentration of the alcohol fuel is increased in relation to vapor pressure thereof. For this reason, the direct alcohol fuel cell of the present invention is subjected to the crossover.

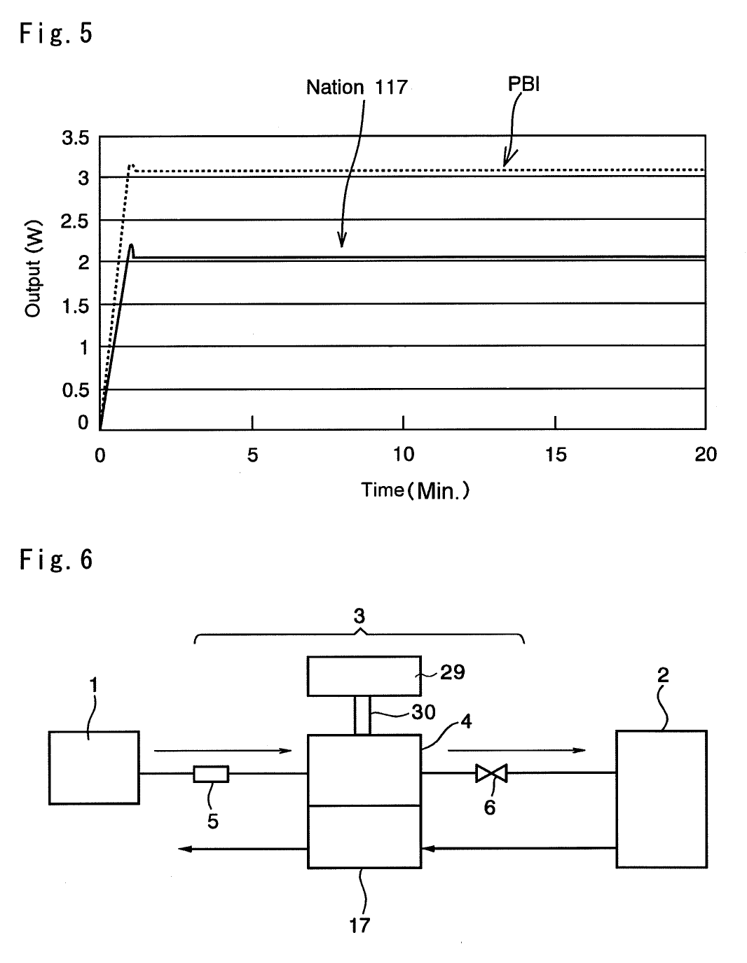

Therefore, in order to avoid or minimize such alcohol crossover, it is preferable to use polybenzimidazole (hereinafter “PBI”) whose glass transition point is as high as the electrolyte membrane. PBI is capable of existing stably even under the steady running state of the direct alcohol fuel cell of the invention (e.g., under the state where the direct alcohol fuel cell outputs constantly and the heat from the catalyst combustion chamber is approximately 200° C.). Therefore, the alcohol crossover scarcely occurs in this case. FIG. 5 is a graph indicating power generating characteristic of the direct methanol fuel cell of the present invention in which PBI is used to form the electrolyte membrane. In FIG. 5, a continuous line represents power generating characteristic of the direct alcohol fuel cell in which a polymer membrane of perfluorosulfonic acid series is used as the electrolyte membrane, and a broken line represents power generating characteristic of the direct alcohol fuel cell in which PBI is used as the electrolyte membrane. As can be seen from FIG. 5, the output of the fuel cell using PBI as the electrolyte membrane is 50% higher than that of the fuel cell using the polymer membrane of perfluorosulfonic acid series as the electrolyte membrane.

Next, here will be explained another example of the direct alcohol fuel cell according to the invention. FIG. 6 is a block diagram schematically showing another configuration of the direct alcohol fuel cell of the present invention. However, further explanation of the elements of FIG. 6 in common with those in the example shown in FIG. 1 will be omitted by allotting common reference numerals as FIG. 1.

As shown in FIG. 6, the fuel cell of another example comprises a gas tank 29 for containing noncondensable gas such as hydrogen peroxide. The gas tank 29 is communicated with the vapor chamber 4 through a noncondensable gas supply conduit 30. Although the gas tank 29 shown in FIG. 6 is adapted to hold noncondensable gas therein, the gas tank 29 may also be adapted to produce noncondensable gas such as oxygen from a hydrogen peroxide solution using manganese dioxide or platinum arranged on the supply conduit 30. In the case of using platinum as the catalyst, platinum decomposes not only the hydrogen peroxide solution but also methanol. Therefore, platinum has to be prevented from being contacted with methanol. In addition, it is necessary to provide a back-flow control mechanism such as a valve for preventing backward flow of decomposition products such as CO₂ decomposed from methanol contacted with platinum to the fuel tank 1 or to the gas tank 29. For these reasons, it is preferable to use manganese dioxide as a catalyst for decomposing the hydrogen peroxide solution in the fuel cell, in which methanol is used as fuel, and in which the hydrogen peroxide solution serves as a generation source of noncondensable gas such as oxygen.

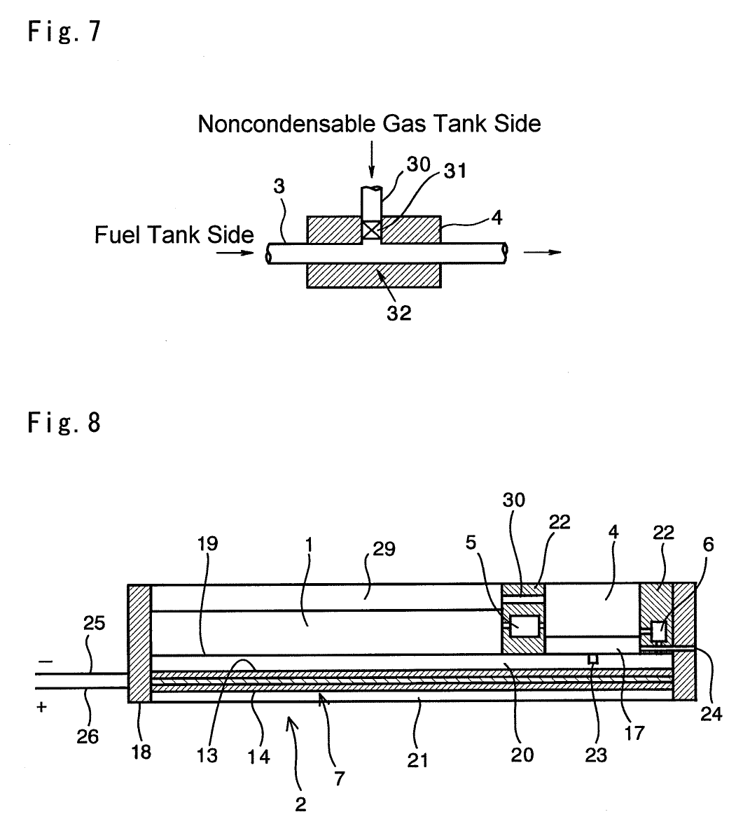

FIG. 7 schematically shows an example of the above-explained configuration for producing noncondensable gas such as oxygen from the hydrogen peroxide solution contained in the gas tank 29. As shown in FIG. 7, the noncondensable gas supply conduit 30 is communicated with the alcohol supply conduit 3 in the vapor chamber 4, and a catalyst 31 for producing oxygen by decomposing the hydrogen peroxide solution is arranged on the noncondensable gas supply conduit 30. A junction of the noncondensable gas supply conduit 30 and the alcohol supply conduit 3 is a noncondensable gas mixing section 32. As explained above, manganese dioxide, platinum or the like can be used as the catalyst 31.

FIG. 8 shows another example of the direct alcohol fuel cell thus far described in more detail. Further explanation of the elements of FIG. 8 in common with those of the example shown in FIG. 3 is omitted by allotting common reference numerals. As shown in FIG. 8, an interior space of the hollow package 18 is divided into two spaces by a partition 19. A fuel tank 1, a noncondensable gas tank 29, a flow regulating mechanism 5, a vapor chamber 4, a catalyst combustion chamber 17 and a valve 6 are arranged in the upper space of package 18. A generating section 2 is arranged in the lower space of the package 18. The generating section 2 is composed mainly of a MEA 7, and the MEA 7 divides the space of the package 18 underneath the partition 19 into two spaces. In addition, gas tank 29 is a sealed container provided with an inlet, not shown.

The liquid methanol is supplied to the vapor chamber 4 from the fuel tank 1, and the flow rate of the liquid methanol is regulated by the flow regulating mechanism 5. The liquid methanol thus supplied to the vapor chamber 4 is heated by the heat from the catalyst combustion chamber 17. In order to startup the fuel cell promptly even under cold climate, an electric heater may be used as an auxiliary heat source. Hydrogen peroxide solution supplied from the gas tank 29 is decomposed by the catalyst 31 arranged on the noncondensable gas supply conduit 30, and oxygen is produced by the dissociation of the hydrogen peroxide solution. The produced oxygen is mixed with alcohol vapor at the noncondensable gas mixing section 32 in the vapor chamber 4. The alcohol vapor mixed with noncondensable gas is supplied to the fuel chamber 20 through the valve 6, and the partial pressure of the methanol fuel supplied to the fuel chamber 20 is reduced. For this reason, re-condensation of the alcohol vapor is prevented so that the fuel can be supplied to the generating section 2 in sufficient amount.

Since the methanol fuel is in gaseous phase when supplied to the fuel chamber 20, the methanol fuel diffuses in the fuel chamber 20 promptly. After the vaporized methanol fuel diffuses all over the surface of the electrolyte membrane 8 through the gas diffusion layer 11, the above-explained reaction is achieved at the catalyst layer 9. Therefore, the generating reaction takes place entirely in the electrolyte membrane 8 thereby generating electric power efficiently.

As expressed by the above equation (1), carbon dioxide is produced at the catalyst layer 9 as a result of dissociation of methanol. However, the methanol fuel is heated to be vaporized when supplied to the catalyst layer 9 and the gas diffusion layer 11, and partial pressure of the methanol fuel is reduced to prevent re-condensation of the alcohol vapor by mixing the noncondensable gas therewith. For this reason, a liquid film will not be formed on the catalyst layer 9 and the gas diffusion layer 11 so that the CO₂ gas resulting from oxidation reaction can be emitted promptly and the methanol fuel can be circulated smoothly. Thus, the methanol fuel is supplied to the catalyst layer 9 and the electrolyte membrane 8 consecutively, thereby generating the electric power efficiently.

The CO₂ gas resulting from the reaction expressed by equation (1) is introduced into the catalyst combustion chamber 17 with oxygen as a noncondensable gas from the admission port 23, and then emitted outside of the package 18 via the exhaust pipe 24. That is, the carbon dioxide gas also carries the unburned methanol to the catalyst combustion chamber 17. The unburned methanol is oxidized to be dissolved into carbon dioxide gas and water in the catalyst combustion chamber 17. Therefore, the methanol fuel will not be emitted from the package 18 (at the most, only scarce methanol fuel is emitted from the package 18). Thus, as has been explained, safeness of the alcohol fuel cell according to the present invention is extremely high. Moreover, the alcohol fuel cell of the present invention does not require any power unit such as a pump so that the fuel cell itself can be downsized. In addition, generated electric power will not by consumed by such power unit. Therefore, generation efficiency of the fuel cell can be improved.

Next, here will be explained a still another example of the direct alcohol fuel cell according to the invention. In the above-explained example, hydrogen peroxide is contained as a generation source of noncondensable gas in the gas tank 29. The hydrogen peroxide solution is decomposed by the catalyst 31 arranged on the noncondensable gas supply conduit 30, and oxygen is produced by the dissociation of the hydrogen peroxide solution. The produced oxygen is mixed with alcohol vapor at the noncondensable gas mixing section 32, in other words, at the junction of the noncondensable gas supply conduit 30 and the alcohol supply conduit 3. In short, the above-explained example is adapted to mix the alcohol vapor with noncondensable gas, and to supply the mixed fuel vapor to the generating section 2. Alternatively, such mixed fuel vapor to be supplied to the generating section 2 may also be prepared in advance by mixing the liquid alcohol with hydrogen peroxide to generate noncondensable gas such as oxygen on the supply route of the mixed fuel.

In this case, a liquid mixture of hydrogen peroxide and alcohol is to be transported through the supply conduit on which the catalyst 31 is arranged so as to decompose hydrogen peroxide contained in the mixed fuel. Here, if manganese dioxide is used as the catalyst 31, only hydrogen peroxide is decomposed by the catalyst 31. That is, alcohol contained in the mixed fuel will not be affected by the catalyst 31.

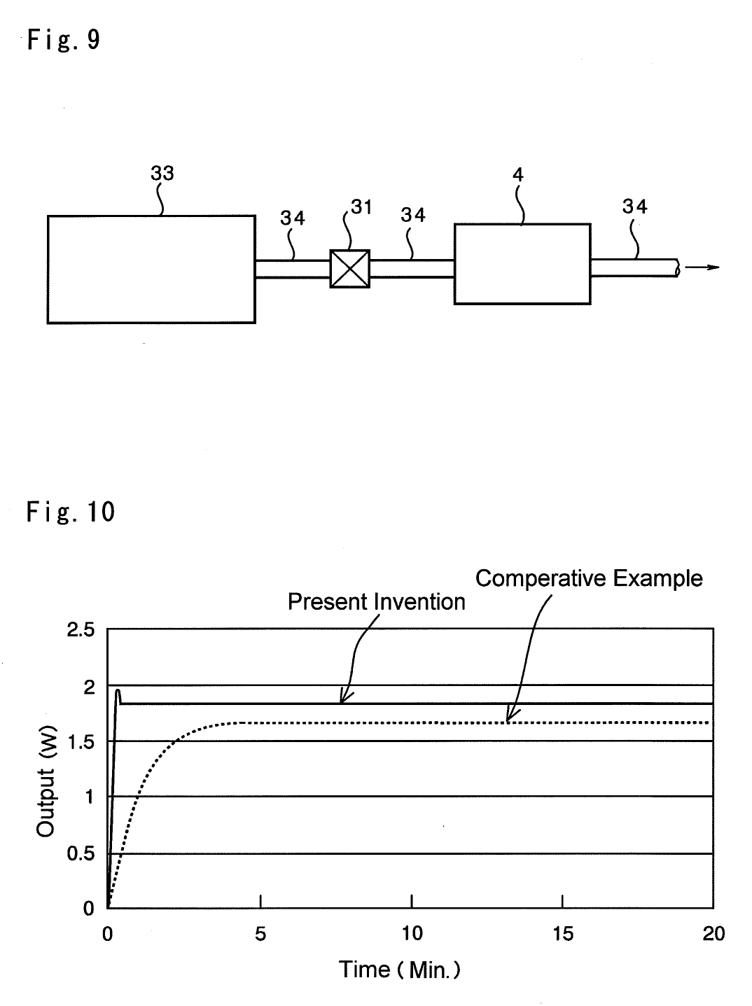

An example of such configuration is shown in FIG. 9. Specifically, the mixed fuel of methanol and hydrogen peroxide solution is contained in a mixed fuel tank 33. As illustrated in FIG. 9, the mixed fuel tank 33, the vapor chamber 4 and the generating section 2 are communicated through a mixed fuel supply conduit 34, and the catalyst 31 is arranged between the mixed fuel tank 33 and the vapor chamber 4. The remaining elements of FIG. 9 are identical to those in FIGS. 3 and 8, so further explanation of the elements in common with those in FIGS. 3 and 8 will be omitted by allotting common reference numerals.

As described, the mixed fuel tank 33 is provided with the mixed fuel supply conduit 34 for supplying the mixed fuel contained in the mixed fuel tank 33 to the generating section 2. In the mixed fuel supply conduit 34, a bundled carbon fiber or porous material to be impregnated with the methanol fuel to achieve capillary action is contained to serve as a wick material, not shown. The hydrogen peroxide solution contained in the mixed fuel supplied from the mixed fuel tank 33 is decomposed by the catalyst 31 arranged on the way to vapor chamber 4, and noncondensable gas such as oxygen is thereby produced. Then, the methanol fuel infiltrating into the wick material is heated to be vaporized.

When the methanol fuel is vaporized, meniscus of the wick material is lowered so that the mixed fuel in the mixed fuel tank 33 is sucked by capillary action. Moreover, since the partial pressure of the methanol vapor is reduced by noncondensable gas, the mixed fuel vapor can be supplied to the generating section 2 promptly and efficiently. In order to halt the feeding of the methanol fuel from the mixed fuel tank 33 to the generating section 2 selectively, an additional valve may be used.

According to the alcohol fuel cell shown in FIG. 9, oxygen is produced by the catalyst 31 arranged on the mixed fuel supply conduit 34. Then, methanol is vaporized in the vapor chamber 4, and the mixed fuel is supplied to the generating section 2. As the alcohol fuel cell shown in FIG. 8, the mixed fuel vapor is used to generate electric power at the MEA 7. As described, the partial pressure of the methanol vapor is reduced when supplied to the fuel chamber so that sufficient amount of the methanol fuel can be supplied thereto. Moreover, the methanol vapor diffuses homogeneously all over the MEA 7 so that electric power can be generated efficiently. As also explained in the explanation of the example shown in FIG. 8, CO₂ gas resulting from the generating reaction can be emitted promptly with noncondensable gas such as oxygen. Therefore, power generation efficiency can be further improved. Specifically, according to the example shown in FIG. 9, the methanol fuel is evaporated from the wick material (not shown) and the meniscus of the wick is thereby changed. As a result, the liquid methanol is sucked by the wick material. That is, the flow rate of the liquid methanol can be regulated automatically. Thus, the example shown in FIG. 9 also does not require any power unit so that the fuel cell can be downsized easily. Moreover, generated power will not be consumed by the power unit so that the power generation efficiency can be further improved as the example shown in FIG. 8.

### Example 2

A fuel cell illustrated in FIG. 8 was prepared. In this example, a diluted methanol solution containing 50% of water was used as fuel. In addition, the concentration of hydrogen peroxide solution was 3%, and manganese dioxide was used as the catalyst for decomposing hydrogen peroxide.

Manganese dioxide was carried on glass fiber by immersing the glass fiber rinsed in advance in a manganese nitrate (i.e., hexahydrate) diluted to 10% concentration with methanol, and heating at 400° C. for one hour. In addition, platinum can also be used as the catalyst instead of manganese dioxide. However, methanol is decomposed by a catalyst action of platinum if an alcohol series, especially methanol is used as the fuel. Therefore, methanol has to be isolated from platinum.

In the fuel cell, both of the vapor chamber and the catalyst combustion chamber are sealed. Dimension of each chamber is 10 mm×10 mm×5 mm, and thickness of each part of those chambers is 1 mm. A wick material prepared by applying hydration treatment to carbon fiber is contained in the vapor chamber, and catalyst particles in which platinum was carried by a metal wick material were contained in the catalyst combustion chamber. The catalyst is prepared by immersing glass fiber rinsed in advance in an aqueous solution containing 10% of hexachloride platonic acid (i.e., hexahydrate), and heating the solution to 300° C. Then, hydrogen is reduced at room temperature thereby carrying platinum on the glass fiber as a wick material.

In this example, Nafion® 117 was used as an electrolyte membrane, and the thickness thereof was 0.1 mm. A blend of equal amount of platinum and ruthenium was used to form a catalyst layer on the fuel chamber side, whereas only platinum was used to form a catalyst layer of air chamber side. The thickness of both catalyst layers was 20 μm. The catalyst layer was prepared by mixing catalyst powder into an alcohol solvent to prepare an ink like material, and forming a catalyst film on a Teflon sheet using a screen printer. The catalyst film on the Teflon sheet was thermally pressed on an electrolyte membrane at 140° C. for five minutes and then cooled while being pressurized to be transferred to the electrolyte membrane.

Further, gas diffusion layers were formed on both catalyst layers of the fuel chamber side and the catalyst layer of air chamber side. Both of the gas diffusion layers were made of hydrated glass fiber and thickness thereof was 1 mm. On both of the gas diffusion layers, there are formed electrodes of platinum-plated stainless steel mesh, and the diameter of each opening of the mesh was 2 mm. Those layered materials were pressed while being heated to be integrated as MEA. In this situation, the area of the electrode was 25 cm² (5 cm×5 cm).

A temperature of a partition plate dividing the vapor chamber and the catalyst combustion chamber was measured after a generation of the fuel cell is stabilized, and it was approximately 200° C. Since the boiling point of methanol is approximately 65° C. under the standard atmospheric pressure, it was conformed that such evolution of heat at the partition was sufficient for vaporizing methanol. FIG. 10 is a graph indicating electromotive force measured in this example. In FIG. 4, specifically, a continuous line represents power generating characteristic of the case in which the vaporized methanol was supplied to the generating section with noncondensable gas, and a broken line represents the power generating characteristics of a comparative example such as a conventional fuel cell in which liquid methanol is supplied directly to a power generating section. As shown in FIG. 10, an output of the direct methanol fuel cell of the invention is higher than that of the comparative example in which liquid methanol is supplied directly to a power generation section. As also shown in FIG. 4, the output of the direct methanol fuel cell of the present invention is much stabilized in comparison with that of the comparative example.

In addition, a transportation amount of the methanol vapor by oxygen produced in advance from hydrogen peroxide was assessed. Although not shown in FIG. 10, according to the invention, the transportation amount of the methanol vapor was 20 g per hour.

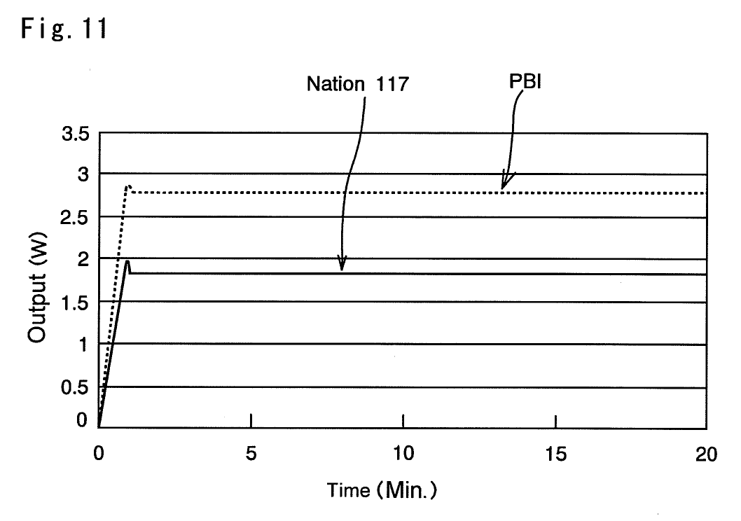

As explained above, the vaporized alcohol fuel is used in the direct methanol fuel cell of the present invention. Therefore, alcohol crossover occurs if a general polymer membrane of perfluorosulfonic acid series is used as the electrolyte membrane. As also explained above, in order to avoid or minimize such alcohol crossover, it is preferable to use PBI whose glass transition point is as high as the electrolyte membrane. FIG. 11 is a graph indicating power generating characteristics of the case in which PBI is used to form the electrolyte membrane of the direct methanol fuel cell of the invention the power generating characteristic thereof is indicated in FIG. 10. In FIG. 11, a continuous line represents power generating characteristics of the direct alcohol fuel cell in which a polymer membrane of perfluorosulfonic acid series is used as the electrolyte membrane, and a broken line represents power generating characteristics of the direct alcohol fuel cell in which PBI is used as the electrolyte membrane. As can be seen from FIG. 11, the output of the fuel cell using PBI as the electrolyte membrane is 50% higher than that of the fuel cell using the polymer membrane of perfluorosulfonic acid series as the electrolyte membrane.

In addition, a wick structured glass fiber is thermally stable and the most preferable material for the wick to be used in the fuel supply conduit, however, cotton or aluminum thin strings can also be used instead of the glass fiber depending on the condition of use. As also mentioned above, temperatures in the vapor chamber and in the catalyst combustion chamber are raised to high temperatures. Therefore, in order to ensure safety and reliability for long use of the fuel cell, the fuel cell is preferably thermally insulated from outside.

Meanwhile, in the case of using the fuel cell in a cold climate, the temperature of generating section may be lowered and startup of the fuel cell is thereby delayed. In order to solve such a disadvantage, it is effective to warm the generating section by transporting the heat generated from the catalyst combustion chamber. For this purpose, conventional members such as a metal plate, heat pipe or the like can be used.

In addition to the above, noncondensable gas can be produced as expressed by the following equation. Specifically, in the case of using hydrogen peroxide, nitrogen gas is produced by contacting hydrogen peroxide with hydrazine.

2H₂O₂+N₂→H₄→N₂+4H₂O

Alternatively, noncondensable gas can be produced by contacting an oxidant, a fuel component and a constituent of additive used according to need.

In this case, the oxidant can be selected from nitric acid series, nitrous acid series, basic nitric acid series, oxo haloid acid salt and so on.

The nitric acid series can be exemplified by nitric acid, ammonium nitrate, sodium nitrate, potassium nitrate, barium nitrate, strontium nitrate and so on.

The nitrous acid series can be exemplified by sodium nitrate, potassium nitrate barium nitrate, strontium nitrate and so on.

The basic nitric acid series can be exemplified by basic cupric nitrate, basic manganese nitrate, basic iron nitrate, basic molybdenum nitrate, basic bismuth nitrate, basic cerium nitrate and so on.

Oxo haloid acid salt can be exemplified by haloid acid salt, hyperhaloid acid salt and so on.

Haloid acid salt can be exemplified by: haloid acid alkali metal salt such as potassium chlorate, sodium chlorate; haloid acid alkaline earth metal salt such as barium chlorate, calcium chlorate; haloid acid ammonium salt such as ammonium chlorate, haloid acid ammonium salt and so on. Hyperhaloid acid salt can be exemplified by hyperhaloid acid alkali metal salt such as potassium perchlorate, sodium perchlorate, hyperhaloid acid alkaline earth metal salt such as barium perchlorate, calcium perchlorate, hyperhaloid acid ammonium salt such as ammonium perchlorate and so on.

The fuel component can be exemplified by implication nitrogen compound, organic acid, salt of organic acid, crystallite carbon particles and so on.

The implication nitrogen compound can be exemplified by nitramine compound, guanidine derivative, tetrazole derivative, triazole derivative, hydrazine derivative azodicarbon amide derivative and so on.

The nitramine compound can be exemplified by trimethylenetrinitramine (RDX), tetramethylenetetranitramine (HMX) and so on.

The guanidine derivative can be exemplified by nitroguanidine, triaminoguanidinenitrate (TAGN) and so on.

The tetrazole derivative can be exemplified by amino tetrazole, tetrazole, bitetrazole and so on.

The triazole derivative can be exemplified by triazole, urazole and so on.

The hydrazine derivative can be exemplified by hydrazine nitrate and so on. The azodicarbon amide derivative can be exemplified by azodicarbon amide, hydrazo dicarbon amide and so on.

The crystallite carbon particles can be exemplified by active carbon, charcoal, coke, activated charcoal prepared from animal substance, animal charcoal pitch coal, carbon black and so on.

Additionally, in order to improve diachronic stability, a diachronic stabilizer may be used as the additive. Here, any kind of diachronic stabilizer can be used.

For example, diphenylurea derivative, diphenylamine derivative, phenylurethane derivative, diphenylurethane derivative can be used as the diachronic stabilizer.

The diphenylurea derivative can be exemplified by diphenylurea, methyldiphenylurea, ethyldiphenylurea, diethyldiphenylurea, dimethyldiphenylurea, methylethyldiphenylurea and so on.

The diphenylamine derivative can be exemplified by diphenylamine, 2-nitro diphenylamine and so on.

The phenylurethane derivative can be exemplified by ethylphenylurethane, methylphenylurethane and so on.

The diphenylurethane derivative can be exemplified by diphenylurethane, resorcinol and so on.

In order to minimize emission of oxide mist of alkaline metal or alkaline earth metal resulting from decomposition of the oxidant, slug formation agent may be used as the additive.

For example, the slug formation agent can selected from silica, alumina, acid clay, talc, mica, molybdenum disulfide. Here, silica, alumina and acid clay are the most preferable material to be used as the slug formation agent.

In addition to above, noncondensable gas such as hydrogen is produced by contacting water with amphoteric metal such as alkaline metal, alkaline earth metal, metal aluminum.

The above explained chemical reactions may proceed explosively. Therefore, in order to ensure the safety, it is preferable to encapsulate any one of the oxidant and the fuel component to reduce reactive surface thereof. Alternatively, it is preferable to carry out the flow rate control more accurately, or to use materials of lower concentration.

Still another example to produce noncondensable gas such as nitrogen is to heat azo compound as expressed by the following equation:

2NaN₃→2Na+3N₂.

Although the above exemplary embodiments of the present invention have been described, it will be understood by those skilled in the art that the present invention should not be limited to the described exemplary embodiments, but that various changes and modifications can be made within the spirit and scope of the present invention.

What is claimed is:

1. A direct alcohol fuel cell, comprising:
a membrane-electrode assembly having electrodes formed on both faces of an electrolyte membrane;
a fuel chamber formed on one electrode;
an air chamber formed on the other electrode;
a fuel tank;
a supply conduit communicating the fuel tank and the fuel chamber; and
a vapor chamber provided on the supply conduit;
wherein the vapor chamber is provided with an oxidation catalyst, and an admission port.

2. The direct alcohol fuel cell according to claim 1, wherein the electrolyte membrane includes polybenzimidazole.

3. The direct alcohol fuel cell according to claim 1, further comprising a liquid alcohol fuel.

4. A direct alcohol fuel cell, comprising:
a membrane-electrode assembly having electrodes formed on both faces of an electrolyte membrane;
a fuel chamber formed on one of the electrodes;
an air chamber formed on the other electrode;
a fuel tank;
a supply conduit communicating the fuel tank and the fuel chamber;
a vapor chamber provided on the supply conduit; and
a noncondensable gas mixing section.

5. The direct alcohol fuel cell according to claim 4, wherein the noncondensable gas mixing section comprises:
a noncondensable gas tank;
a noncondensable gas supply conduit communicating the supply conduit and the noncondensable gas tank; and
a catalyst provided on the noncondensable gas supply conduit.

6. The direct alcohol fuel cell according to claim 6, wherein the noncondensable gas mixing section further comprises:
a mixed fuel supply conduit; and
a catalyst arranged on the mixed fuel supply conduit.

7. The direct alcohol fuel cell according to claim 5, wherein the noncondensable gas is hydrogen peroxide.

8. The direct alcohol fuel cell according to claim 1, wherein the oxidation catalyst includes platinum.

9. The direct alcohol fuel cell according to claim 5, wherein the catalyst is selected from a group consisting of platinum and manganese dioxide.

10. The direct alcohol fuel cell according to claim 1, wherein the liquid alcohol fuel includes methanol.

11. The direct alcohol fuel cell according to claim 1, wherein heat generated as a result of oxidizing unburned alcohol fuel at the oxidation catalyst is transferred to the alcohol in the supply conduit.

12. The direct alcohol fuel cell according to claim 1, further comprising an external heat source provided at the vapor chamber.

13. The direct alcohol fuel cell according to claim 1, wherein combustion heat of the alcohol fuel is transferred to the alcohol in the supply conduit.

14. The direct alcohol fuel cell according to claim 4, further comprising an external heat source provided at the vapor chamber.

15. The direct alcohol fuel cell according to claim 4, wherein heat generated as a result of oxidizing unburned alcohol fuel at the oxidation catalyst is transferred to the alcohol in the supply conduit.

16. The direct alcohol fuel cell according to claim 7, wherein the concentration of hydrogen peroxide in the liquid alcohol fuel is within 10 wt %.

17. The direct alcohol fuel cell according to claim 1, further comprising a gas diffusion layer provided between the electrolyte membrane and the electrode.

18. The direct alcohol fuel cell according to claim 4, further comprising a gas diffusion layer provided between the electrolyte membrane and the electrode.
